(19) United States
(12) Patent Application Publication
(10) Pub. No.: US 2016/0228312 A1
(43) Pub. Date: Aug. 11, 2016

(54) WHEELCHAIR PUSH-BAR ACCESSORY

(71) Applicant: Greenmont Healthcare Products, LLC, Manchester, CT (US)

(72) Inventors: Matthew QUINN, Manchester, CT (US); Stephen POTOFF, Wellesley, MA (US); Rubin POTOFF, North Franklin, CT (US); Pavel MENN, Salem, MA (US)

(21) Appl. No.: 15/018,918

(22) Filed: Feb. 9, 2016

Related U.S. Application Data
(60) Provisional application No. 62/113,751, filed on Feb. 9, 2015.

(51) Int. Cl. A61G 5/10

(52) U.S. Cl. CPC A61G 5/10

(57) ABSTRACT

A push-bar includes a cross-bar which has two ends and a longitudinal cross-bar axis from end to end, and a mounting member mounted on each end of the cross-bar and extending along a mounting member axis. Each mounting member defines an aperture for receiving therein and encircling a wheelchair handle and includes a clamp mechanism for engaging a wheelchair handle disposed in the aperture.

### CROSS-REFERENCE TO RELATED APPLICATION

This application claims the benefit of U.S. provisional application No. 62/113,751 filed Feb. 9, 2015, the contents of which are incorporated herein by reference in their entirety.

### FIELD OF THE INVENTION

This invention relates to push-bars for wheelchairs and other hand-propelled vehicles, and in particular to an accessory for the handles of such vehicles.

1. Background

Wheelchairs have long been designed for two people to propel them: the wheelchair-bound user of the wheelchair and an attendant who accompanies the user. A wheelchair user often makes use of hand rims on the wheels of the wheelchair, which the user can grasp to force the wheels to turn and thus propel the wheelchair. Alternatively, an attendant pushes and controls a wheelchair by grasping a pair of horizontally-disposed handles that extend rearward from the wheelchair frame. These traditional wheelchair handles, however, do not provide the most ergonomic design for use by the attendant. For this reason, a variety of wheelchair handle accessories have been invented in the past to offer attendants alternatives to traditional wheelchair handles.

2. Related Art

U.S. Pat. No, 5,290,055 to Treat, Jr., discloses a push-bar apparatus for use with a wheelchair, allegedly to permit one-handed pushing of the wheelchair by an attendant. The embodiment of FIGS. 1-4 shows a U-shaped configuration defined by a central tubular member 20 and a pair of tubular sleeves extending therefrom at opposite ends of the central tubular member, and connected thereto via an elbow bend so that each tubular sleeve (from the central tubular member to the end of the sleeve) is parallel to the other and is at right angles to the central tubular member. The tubular sleeves are sized and configured so that they can receive therein the handles of the wheelchair, in a direction aligned with the length of the sleeve. Each sleeve has a set screw disposed transversely to the tubular sleeve to permit a user to secure the apparatus onto the wheelchair handles.

U.S. Pat. No. 5,915,712 to Stephenson et al. discloses a plash-bar apparatus for use with a wheelchair, the apparatus including a pair of tubular, sleeve-like connectors that slide onto the wheelchair handles and that are secured on the handles by way of screws that extend transversely through the connectors via threaded holes in the connectors. The apparatus includes a U-shaped cross bar 21 having a straight horizontal center portion and two vertical end portions perpendicular to the center portion. Each vertical end portion includes a support post 22 at each end which extends orthogonally to both the central portion of the cross bar 21 and the end portions, giving the apparatus a three-dimensional x-y-z axis configuration on its own and when mounted on a wheelchair.

U.S. Pat. No. 4,964,648 to Berkowitz discloses an adapter handle 10 for use on a wheelchair. The adapter handle comprises a cross-bar (“elongate arm 12”) which spans the wheelchair handles. The cross-bar carries two carriages 14, each of which carries complex, multi-component mechanism for allowing the adapter handle to be placed upon the wheelchair handles and then, by the operation of a pivoting lever or latch handle 32 and pressure plate, clamped onto the wheelchair handles.

### SUMMARY OF THE INVENTION

According to a first embodiment, a push-bar kit for constructing a push-bar, or an assembled push-bar, comprises a cross-bar which has two ends and a longitudinal cross-bar axis from end to end and a pair of mounting members each configured for mounting on an end of the cross-bar, and each mounting member comprising a clamp fixture which defines an aperture for receiving and encircling a wheelchair handle. Each mounting member includes a clamp mechanism for engaging a wheelchair handle disposed in the aperture.

In one optional aspect, the clamp fixture defines a bracing surface and the clamp mechanism includes a screw shaft having one end in the aperture and a clamp head on the end of the screw shaft in the aperture for advancing and retracting the clamp head relative to the bracing surface.

According to another aspect, the aperture has a width, and the maximum height between clamp head and the bracing surface is at least the same as width of the aperture.

Optionally, each mounting member comprises a mounting post having a first portion and a second portion, wherein each first portion is configured for axial telescopic engagement in the end of the cross-bar.

In another optional aspect, the aperture extends linearly through the clamp fixture.

In one embodiment, each aperture has a depth of at least about 3 centimeters.

### BRIEF DESCRIPTION OF THE DRAWINGS

FIG. 1 is a perspective view of one embodiment of a push bar described herein.

FIG. 2 is a partly exploded cross-sectional view of the mounting member of the push bar of FIG. 1.

FIG. 3 is a perspective view of another embodiment of a mounting member for a push-bar as described herein.

FIG. 4 is an exploded view of one embodiment of a cross-bar for use in a push-bar as described herein.

FIG. 5A is a cross-sectional view of a longitudinal half of on embodiment of a cross-bar for use in a push-bar as described herein.

FIG. 5B is a perspective view of the half of the cross-bar of FIG. 5A.

FIG. 6 is a partial perspective view of a wheelchair equipped with a an illustrative embodiment of a push-bar as described herein.

### DETAILED DESCRIPTION

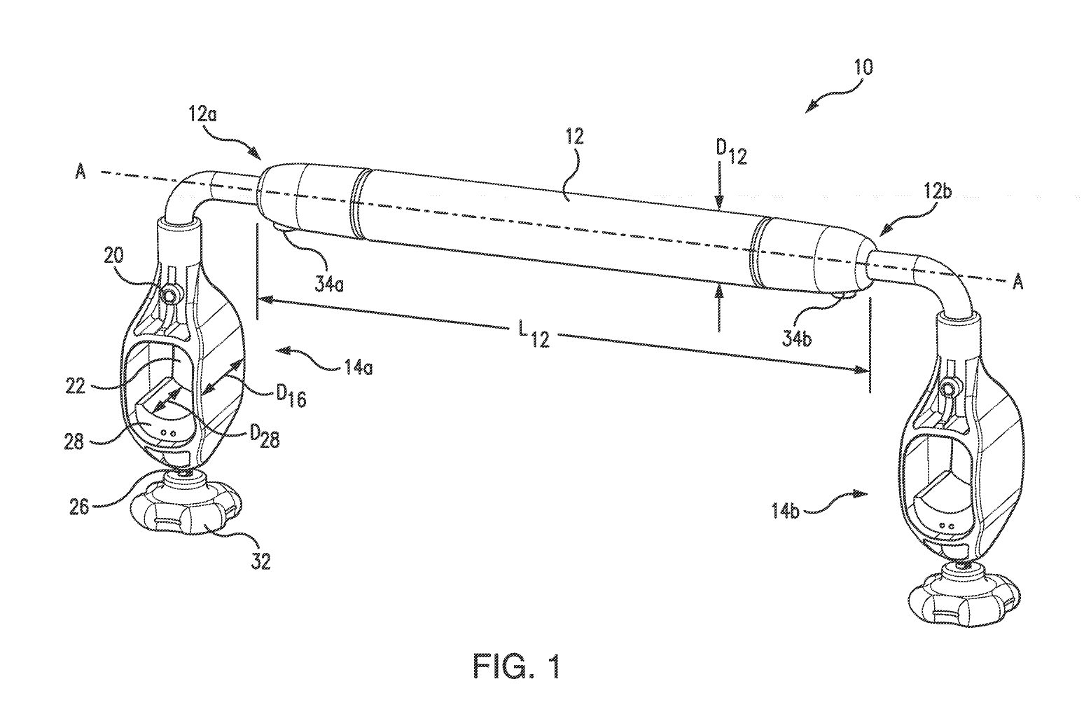

According to a first embodiment, a push-bar 10 shown in FIG. 1 includes a cross-bar 12 having two ends 12a, 12b, and mounting members 14a and 14b, one being mounted on each end of the cross-bar. The cross-bar has a length L₁₂ of about 30 centimeters (cm) (about 12 inches (in.)) and a diameter D₁₂ of about 3 cm (about 1.25 in.), but the invention is not limited in this regard and in various embodiments, L₁₂ may be longer or shorter and D₁₂ may be larger or smaller. In a preferred optional embodiment, a cross-bar as described herein would have a configuration resembling the handle on a shopping cart. The cross-bar 12 has a cross-bar axis A-A extending longitudinally and centrally therethrough from end 12a to end 12b. In one embodiment, the cross-bar 12 is configured to have an opening at each end 12a, 12b to receive the mounting members therein.

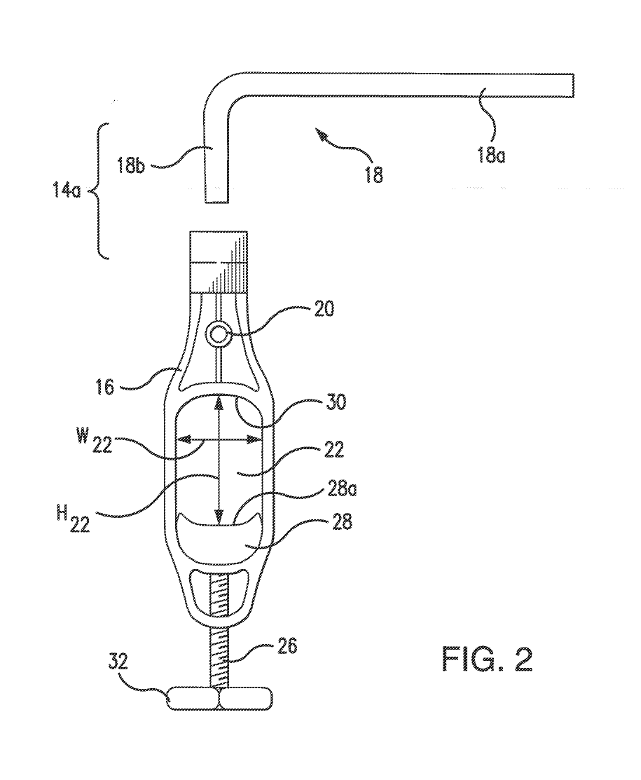

As shown in FIG. 2 as well as in FIG. 1, the mounting member 14a comprises a clamp fixture 16 mounted on an angled mounting post 18. The mounting post has two ends and a first portion 18a at one end which is configured for insertion axially into end 12a of the cross-bar 12. The mounting post 18 has a second portion 18b near the other end, on which the clamp fixture 16 is secured. For example, the second portion 18b may be insertable into the clamp fixture 16 and secured therein by a set screw 20, or by adhesive, a weld, a mechanical lock or any other suitable means. The first portion 18a of the mounting post is angled relative to the second portion 18b, preferably at right angles, but this is not a limitation on the invention and in other embodiments, the angle may be obtuse or acute. Optionally but preferably, the mounting post can lie flat on a surface because the first portion and second portion are co-planar despite the angled configuration.

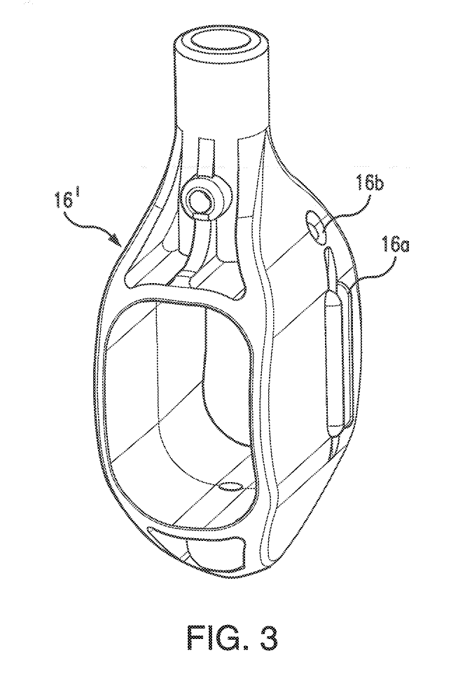

The clamp fixture 16 is configured to be mounted on a wheelchair, in particular, on the handles of a wheelchair. For this purpose the clamp fixture 16 forms an aperture 22 which is sized to receive and encircle a wheelchair handle as indicated in FIG. 3. As shown, the aperture 22 extends linearly through the clamp fixture 16, i.e., the aperture is configured such that a wheelchair handle can be received on one side of the clamp fixture via the aperture and can pass through and extend beyond the other side of the clamp fixture via the aperture.

To better secure the push-bar 10 on a wheelchair handle, the clamp fixture 16 includes a clamp mechanism comprising a screw shaft 26 which passes through the clamp fixture and engages the housing with screw threads so that one end of the screw shaft (the “first” end) extends into the aperture 22. There is a clamp head 28 pivotably mounted on the first end of the screw shaft 26, in the aperture 22. The clamp head 28 has a clamping face 28a which faces a bracing surface 30 inside the aperture 22. As seen in FIG. 1, the depth D₂₈ of the clamp head 28 is the same, or nearly the same, as the depth D₁₆ of the clamp fixture 16. Together, the clamping face 28a and the bracing surface 30 define between them the open portion of the aperture 22 with width W₂₂ and height H₂₂. Since the screw shaft 26 is threaded into the clamp fixture 16, the clamp head 28 and clamping face 28a can be advanced toward, or retracted from, the bracing surface 30 by turning the screw shaft 26 in the appropriate direction, thus adjusting the size of the open portion of the aperture 22.

The aperture 22 is sized to receive a typical wheelchair handle centrally therein. For example, in one embodiment, aperture 22 has a width W₂₂ of about 3.5 centimeters (cm) so that it can accommodate a conventional wheelchair handle centrally therein. However, the invention is not limited in this regard and in other embodiments, W₂₂ may be a different width, e.g., from about 2 cm to about 6 cm.

When the screw shaft is in a retracted position, the height H₂₂ of the aperture 22 between the clamping face 28a and the bracing surface 30 is sufficient to permit a wheelchair handle to pass between them through the aperture, with little or no resistance. Height H₂₂ should at its maximum be at least about 2.5 cm, preferably at least 3 or, for example, at least 3.5 cm. Optionally, the smallest maximum height H₂₂ is at least the same as width W₂₂. By advancing the screw shaft 26, the height H₂₂ is reduced and clamp head 28 can be pressed against a wheelchair handle in the aperture to secure the push bar 10 onto the wheelchair.

In one embodiment, the second end of the screw shaft 26 has a knob 32 (FIG. 1) fixed thereto so that a user can conveniently turn the screw shaft to advance or retract the clamp head 28, and so mount or remove the push-bar 10 from a wheelchair, by hand. Optionally, the knob 32 may be removably mounted on the second end of the screw shaft 26 and in the absence of the knob, a user would need a tool in order to turn the screw shaft. For example, the second end of the screw shaft may be recessed within the clamp fixture 16 and configured to receive a hex key or even a less common kind of driver, so that unequipped users would be inhibited from removing the push-bar 10 from the wheelchair. Optionally, a clamping fixture as described herein may include a driver seat for storing the driving tool, e.g., clamp fixture 16″ (FIG. 3) is equipped with a press-fit slot 16a and recess 1b for receiving the handle and head, respectively of a hex key.

Mounting member 14b has the same construction as mounting member 14a, although the invention is not limited in this regard and in other embodiments, mounting member 14a may differ from mounting member 14b.

In a preferred embodiment, the first portion of a mounting post 18 is received telescopically within cross-bar 12 via end 12a. As a result, mounting member 14a can be disposed at a variety of distances from end 12a; mounting member 14b can likewise be disposed at various distances from end 12b. In this way, push-bar 10 can be adjusted to be mounted on wheel chair handles at a variety of widths from one wheelchair handle to the other. A typical range of widths Wwc is about 30 to about 65 cm (about 12 to about 24 inches). However, the invention is not limited in this regard and in other embodiments, mounting member 14a and/or mounting member 14b may be fixedly mounted on the cross-bar 12 rather than telescopically mounted. Cross-bar 12 has set screws 34a, 34b at ends 12a and 12b, respectively, to secure mounting member 14a and mounting member 14b in place once they are set at the desired wheelchair width. The heads of set screws 34a, 34b may be recessed into the surface of the cross-bar 12 and configured to be tightened by a driving tool, or may protrude to have finger holds (e.g., a thumb screw), or a knob, for hand-tightening.

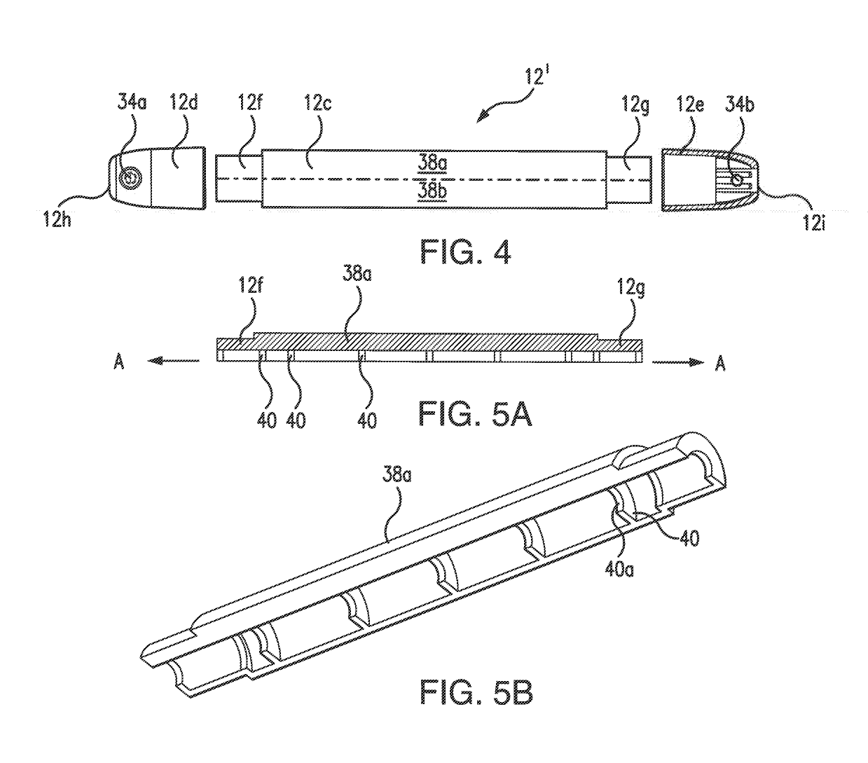

In one embodiment, shown in FIG. 4, a cross-bar 12′ is configured to comprise a central portion 12c combined with an end cap 12d, 12e at each end. The ends 12f, 12g of the central portion 12c are smaller in diameter than the rest of the central portion, and the end caps 12d, 12e are configured to be fitted over, and to be secured to, the ends 12f, 12g (e.g., by adhesive, welding, a screw thread engagement, etc.) and to have outer surfaces which match the outer surface of the central portion 12c to provide a continuous outer surface to the cross-bar 12, from end to end. The previously mentioned set screws 34a, 34b may be disposed in the end caps 12d, 12e. The end caps have the openings 12h, 12i formed therein to receive the first portions 18a of the mounting posts 18 therein.

In one embodiment, a cross-bar is substantially tubular. Optionally, cross-bar 12′ may be molded in two longitudinal, substantially matching halves 38a, 38b and the halves are configured so that when they are assembled together, they cooperate to define a substantially continuous, optionally cylindrical, outer surface for the central portion 12c as seen in FIG. 4.

According to one embodiment, the halves 38a, 38b may be configured as semi-tubular shells and also be equipped with a plurality of internal fins extending radially inward from the shell toward the cross-bar axis A-A, as indicated for half 38a in FIG. 5A and FIG. 5B. Fins 40 on one half 38a of the cross-bar engage fins on the other half 38b to provide mechanical support to the cross-bar 12. The fins 40 may be equipped with carve-outs 40a which cooperate (when a fin on one half engages a fin on the other half) to form apertures inside the cross-bar 12 that are aligned with the openings 12h, 12i at the ends 12a, 12b of the cross-bar, for receiving the mounting members 18.

Optionally, the push-bar 10 is configured to permit adjustment of the height of the cross-bar 12 above the wheelchair handles, e.g., by providing an upwardly telescoping portion in the mounting posts.

The overall configuration of push-bar 10 (as assembled with mounting members secured in the ends) is such that it can lay flat against a surface and so may easily be stacked, packaged and stored alone or with other similarly configured push-bars, due to the limited number of angles in the push-bar. Alternatively, the cross-bar 12 and mounting members 14a, 14b may be provided in an unassembled state and yet together constitute a push-bar kit that can easily be stored, shipped and assembled as shown.

Optionally, the clamp fixture 16, knobs 32, and clamp heads 28 are molded or machined from nylon, ABS or another polymeric material, and the mounting posts 30 and screw posts 26 are formed from steel; but the use of these named materials is not a limitation on the invention and any other materials may be used which provide adequate strength to serve the function described herein.

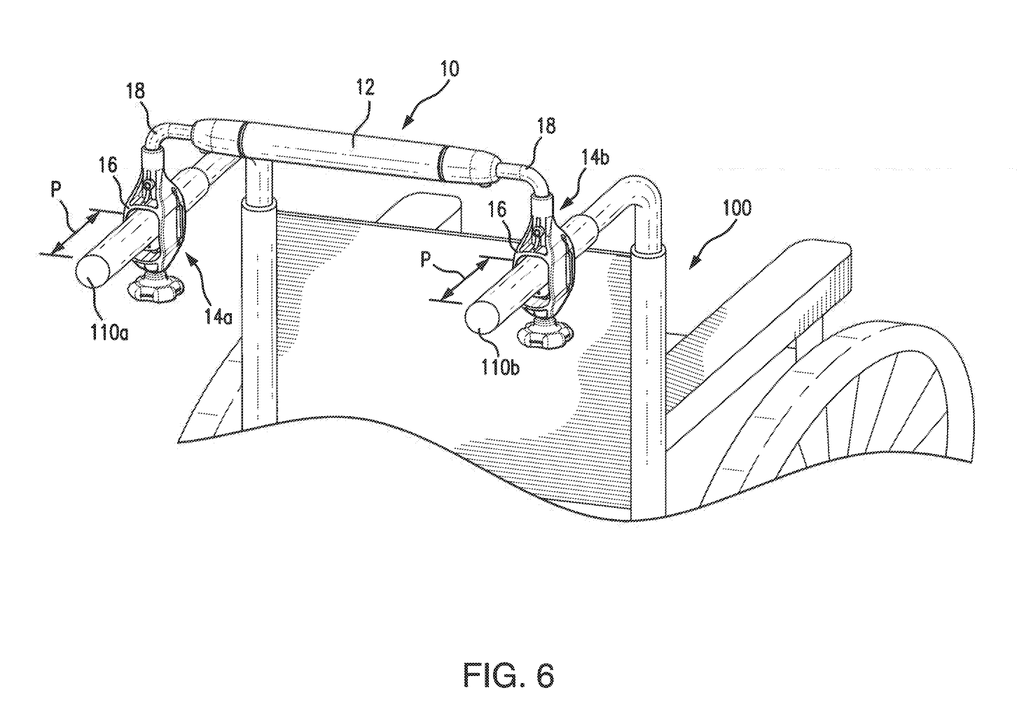

The push-liar 10 is used as follows: Mounting member 14a and mounting member 14b are inserted into the respective ends of cross-bar 12 to assemble the pushy bar. The wheelchair 100, FIG. 6 on which the push-bar 10 will be mourned is selected and the width (FIG. 1) of the push-bar 10 is matched to the wheelchair handles 110a, 110b, which comprise rubber grips so that the handles can be inserted into the apertures 22. The screw shafts 26 are adjusted to allow the handles to be inserted into the apertures 22 (FIG. 1) to a desired position on the handles, and the screw shafts are then turned to tighten the clamp head 28 onto the wheelchair handles. A resulting configuration, shown in FIG. 5, permits an attendant to easily grasp the cross-bar 12 and comfortably push and otherwise manipulate the wheelchair 100.

Optionally but advantageously, when the push-bar 10 is mounted on the handles of a wheelchair as shown in FIG. 6, the cross-bar 12 is situated higher than the handles, preferably by at least 5 cm, more preferably at least 7 cm or, in a particular embodiment, by about 7.5 cm, but the invention is not limited in this respect and other heights of the cross-bar above the handles are feasible and may be useful. This allows an attendant to push the chair without having to hunch over or bend down, and provides improved bio-mechanical leverage for pushing the wheelchair, and improves comfort and control. However, the invention is not limited in this regard and in other embodiments, the push-bar 10 can be mounted with the cross-bar 12 lower than the wheelchair handles. In addition, the cross-bar is situated above the handles (rather than behind them relative to the rest of the wheelchair) means that using push-bar 10 does not require an attendant to stand farther behind the wheelchair than would be necessary if the handles were being used. Therefore, using the push-bar 10 does not inhibit communication between the attendant and the patient in the chair, and the attendant does not have a diminished view of the ground directly in front of the wheelchair.

It can also be seen that push-bar 10 is positioned on handles 110a, 110b so that a portion P of the wheelchair handles protrudes rearward through the mounting members 14a and 14b. This allows the attendant to be closer to the wheelchair than he or she would if they grasped the handles, thus improving communication and vision relative to the use of the handles without the push-bar. In addition, the portions P of the handles therefore remain available for use by an attendant to push or turn the wheelchair if needed or desired, and are also available for impromptu use as pegs on which the patient's belongings (e.g., a purse, sweater or tote bag or a caretaker's accessory (e.g., a medical chart) may be hung.

Having adequate depths D₁₆ and D₂₈ provides for a secure attachment to wheelchair handles positioned in the aperture 22 and also prevents damage to foam or rubber wheelchair handle grips, both advantages being otherwise difficult to attain when a wheelchair handle passes transversely through a mounting fixture of a push-bar as opposed to being inserted axially as taught by Treat, Jr. (supra). In one embodiment, D₁₆ is the same as D₂₆ and both are at least about 4 cm, e.g., they may be about 5 cm, or more. However, the invention is not limited in this regard and in other embodiments, the depth D₁₆ and D₂₈ are both at least about 3 cm, and may be in a range of about 3 cm to about 6 cm or more. In all such embodiments, this invention provides a secure attachment to the wheelchair handles without damage to foam or rubber handle grips in a push-bar configuration in which the wheelchair handles are inserted transversely through an aperture in a mounting member portion of the push-bar. No such advantage for a push-bar configured in this way is known in the art. Preferably, when the clamping face 28a faces upward, both D₁₆ and D₂₈ are greater than the distance between two adjacent ridges between finger rest indentations in contoured hand grips that are common on wheelchair handles, e.g., D₁₆ and D₂₈ are both about 3 cm, or more; optionally about 3.5 cm, or more; in one embodiment, about 4 cm, or more.

Optionally, the mounting posts 18 are configured to form obtuse angles so that their respective second portions 18b diverge from each other when their first portions 18a are mounted in the cross-bar 12. One optional feature of push-bar 10 is that there are no structures protruding laterally beyond the clamp fixture 16. As a result, the cross-bar 12 will not protrude laterally beyond the wheelchair handles, regardless of where the mounting members 14a and 14b are positioned relative to the cross-bar 12, and regardless of the handle-to-handle width of the wheelchair. In other words, the distance from one mounting member to the other (e.g., from the center of the aperture in one clamp fixture to the center of the aperture in the other clamp fixture) is more than the length L₁₂ of the cross-bar 12. This is in contrast to the device shown by Berkowitz (supra), in which the cross-bar will protrude to the sides of a narrow wheelchair on which the device is mounted. Having protruding bar can cause significant inconvenience when trying to push the wheelchair through narrow passages (e.g., airplane aisle) or in congested environments (e.g., nursing home hallways and doorways), where the protruding ends of the bar can strike passers-by, other wheelchairs, door frames, etc.

Prior art devices that are configured to provide a higher pushing height than wheelchair handles lack a generally flat, planar configuration because they include multi-angled mounting members; others permit portions of the cross-bar to protrude beyond the sides of a narrow wheelchair and also require. complicated lever mechanisms to mount securely on the wheelchair handles. In contrast, certain embodiments of the present invention provide the benefits of being substantially planar and providing a higher (than the wheelchair handles) push bar employing a mounting mechanism which does not require a levered pressure plate and in which the handles pass through apertures in the mounting fixtures.

In selected embodiment, the features and advantages described herein are attained by providing a mounting fixture having a simple clamp mechanism, e.g., without the need for lever-based clamps or other types of clamping mechanisms.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art upon a reading and understanding of the foregoing disclosure that numerous variations and alterations to the disclosed embodiments will fall within the scope of this invention and of the appended claims.

What is claimed is:

1. A push-bar kit comprising:
a cross-bar which has two ends and a longitudinal cross-bar axis from end to end;
a pair of mounting members each configured for mounting on an end of the cross-bar, and each mounting member comprising a clamp fixture which defines an aperture for receiving and encircling a wheelchair handle, and each mounting member including a clamp mechanism for engaging a wheelchair handle disposed in the aperture.

2. The push-bar kit of claim 1 wherein the clamp fixture defines a bracing surface and the clamp mechanism includes a screw shaft having one end in the aperture and a clamp head on the end of the screw shaft in the aperture for advancing and retracting the clamp head relative to the bracing surface.

3. The push-bar kit of claim 2 wherein aperture has a width, and the maximum height between clamp head and the bracing surface is at least the same as width.

4. The push-bar kit of claim 1 wherein each mounting member comprises a mounting post having a first portion and a second portion, wherein each first portion is configured for axial telescopic engagement in the end of the cross-bar.

5. The push-bar kit of claim 1 wherein the aperture extends linearly through the clamp fixture.

6. The push-bar kit of claim 1 wherein each aperture has a depth of at least about 3 centimeters.

7. A push-bar comprising:
a cross-bar which has two ends and a longitudinal cross-bar axis from end to end; and
a mounting member mounted on each end of the cross-bar;
wherein each mounting member comprises a clamp fixture which defines an aperture extending linearly therethrough for receiving and encircling a wheelchair handle and including a clamp mechanism for engaging a wheelchair handle disposed in the aperture.

8. The push-bar of claim 7 wherein the each clamp fixture defines a bracing surface and each clamp mechanism includes a screw shaft having one end in the aperture and a clamp head on the end of the screw shaft in the aperture for advancing and retracting the clamp head relative to the bracing surface.

9. The push-bar of claim 8 wherein each aperture has a width, and the maximum height between clamp head and the bracing surface is at least the same as width.

10. The push-bar of claim 7 wherein the distance between the mounting members is greater than the length of the cross-bar.

11. The push-bar of claim 7 wherein each aperture has a depth of at least about 3 centimeters.
